(19) United States
(12) Patent Application Publication
(10) Pub. No.: US 2025/0139080 A1
(43) Pub. Date: May 1, 2025

(54) SYSTEMS, METHODS, AND DEVICES TRACKING AND TOKENIZING ACTIONS

(71) Applicant: Nathan OTTO, Greenwood Village, CO (US)

(72) Inventor: Nathan OTTO, Greenwood Village, CO (US)

(21) Appl. No.: 18/681,837

(22) PCT Filed: Aug. 8, 2022
(86) PCT No.: PCT/US2022/039732

§ 371 Date: Feb. 6, 2024

Related U.S. Application Data
(60) Provisional application No. 63/230,628, filed on Aug. 6, 2021.

(51) Int. Cl. G06F 16/23; G06F 21/60

(52) U.S. Cl. CPC G06F 16/2365

(57) ABSTRACT

Devices, systems, and methods for improving the generation and verifiability of metrics, particularly outcome metrics. Utilizing cryptographically secure mechanisms, such as those underlying NFTs and cryptocurrency, outcomes for a variety of purposes, including charitable purposes, are verified. In some embodiments, an apparatus for providing verifiable outcome metrics comprises (i) a computing device receiving data comprising an actor (e.g., a social good entrepreneur, producer, organization, etc.), an action by the actor (e.g., volunteering time, increasing education, improving nutrition, taking positive environmental action, helping in a disaster, etc.) and an outcome comprising measurement of an effect of the action (e.g., meals delivered, classes taken, fresh foods gardened, support group meetings held), (ii) encoding the data, and (iii) recording the data on a blockchain.

### CROSS-REFERENCE TO RELATED APPLICATIONS

This application claims priority pursuant to 35 U.S.C. § 371 and is a U.S. National Phase application of PCT/US2022/039732 filed Aug. 8, 2022, which claims priority pursuant to 35 U.S.C. § 119(e) to U.S. Provisional Application No. 63/230,628 filed Aug. 6, 2021, which are incorporated herein by reference in their entireties.

### FIELD OF THE INVENTION

The present disclosure relates to outcome metrics, including in the context of activities intended to produce specific results.

### DISCUSSION OF THE BACKGROUND

In a perfect world, accurate metrics would be available for each action a device can take. In most cases, it is desirable that actions, whether AI, mechanical or human, be driven by metrics. Self-driving cars analyze environmental data in selecting actions. Thermocouples are well known measuring devices in which metrics about temperature are generated, typically for use in automated decisions such as whether a heating or cooling system should activate or deactivate. Real estate records are used to automatically generate property tax invoices to create the outcome of revenue flowing to taxing authorities.

There is a substantial difference between input metrics and output metrics. Using the simple example of internal combustion engine (“ICE”) performance, one may fuel an ICE vehicle with 87, 89, or 91 octane fuel. The vehicle characteristics plus the fuel characteristics comprise input metrics. Based on the input metrics, we can estimate performance. If, instead, we directly measure vehicular performance, we are measuring an output metric. While both methods can be used to determine performance, the output metric is far more accurate while avoiding risks associated with confusing causation and correlation as well as risks associated with coincidental relationships (i.e. the octane of the fuel did not make a difference, but other unmeasured factors were responsible for causing performance to behave coincidentally as if octane mattered).

The instant inventions disclose a system, method, and apparatus for improving the generation and accuracy of metrics such as outcome metrics.

As a preliminary matter, we teach the inventions herein in a manner intended to be easily accessible to those skilled in the art. To make the teachings herein more accessible, we do not sharply distinguish between a discussion of the background of the field and discussion of the instant inventions. Accordingly, while we discuss background material outside of the summary and detailed description of invention sections, we may also discuss novel, non-obvious and useful inventions outside of those sections, such as in the introduction or the background section. Inclusion of matter within a given section is not an acknowledgement that the matter is prior art and should not be so construed. Put another way, much of the material throughout the document is intended to provide a general overview of material that might help provide context helpful to teaching those skilled in the art how to implement the inventions. No admission or acknowledgement regarding whether any of the material discussed in these sections is prior art is intended, nor should one be inferred. Without limiting the generality of the foregoing, it is specifically the case that the “background” section may contain or describe some or all of the invention and/or material that post-dates the priority date of this application.

For a wide range of activities, accurate metrics are not possible using existing technology. For many scientific applications, the Heisenberg Uncertainty Principle (which, while common understood to mean that observation can alter the thing being observed, actually states that the more precisely the position of some particle is determined, the less precisely its momentum can be predicted from initial conditions, and vice versa) means that actions triggered when particles meet certain conditions relating to both momentum and position cannot rely on the simultaneous accuracy of both metrics. Quantum superposition similarly means that actions cannot be triggered by measuring the position of certain particles without also causing the particle to move to one of the two positions it simultaneously occupies. Both issues mean that measuring the outcome of actions taken based on data about particles may be inaccurate.

Similar and/or analogous issues in identifying actions to be taken based on metrics exist in many places other than quantum physics. In one example, uploading files to the United States Patent and Trademark Office's (“USPTO”) Electronic Filing System (“EFS”) requires meeting certain metrics regarding compliance with the PDF/A format. It is possible for a file to be certified as PDF/A compliant by Adobe Acrobat®, yet be rejected by the USPTO servers based on the (incorrect) assumption that the outcome of converting the file to PDF/A resulted in an unrenderable file. In a specific example, a certified PDF/A file containing graphics that are associated with rendering instructions calling for dimensions greater than a certain size will be rejected by the EFS even though the files are rendered properly within PDF software. In another example, software registration codes are often tied to hardware configurations. The software should run on the same computer it was installed on, but small variations in the metrics, such as a replacement of ethernet hardware and the associated change in MAC address, may incorrectly cause the software not to run.

Transfer of information such as metrics to humans may similarly fail because the metrics are unreliable or inaccurate. In one example, social media algorithms may suggest a new “friend” based on outdated metrics, such as location, or inaccurate metrics. In another example, face recognition software may take an action or suggest that a human take an action even though the metrics used have failed to properly identify the face. Humans are able to achieve facial recognition with approximately 97.5% accuracy. Google was able to achieve approximately 99.6% accuracy using an artificial neural network. This disparity reveals another challenge to validation of information: Assuming that there is 100% overlap between the 97.5% human-recognized faces with the 99.6% Google-identified faces, this means that out of every 100 faces not recognized by humans, only 84 will be recognized by a computer. Because the human is unable to verify the computer's recognition of a face in those 84 cases, humans may be reluctant to accept as true the computerized results. There are certain analogies to self-driving vehicles. Even if the number of vehicular accidents is reduced by 90% with a switch to self-driving, many humans will underestimate their risk of causing an accident when driving, leading them to incorrectly believe that self-driving is more dangerous.

The problem illustrated by the face recognition example sits dead-center in verification and validation of actions. Without a highly secure and reliable method of verifying actions, it is unlikely that humans would be willing to accept a computer vouching for the truth of a reported action.

The situation often worsens when the data feeding the metrics is self-reported.

In conjunction with less mundane decision-making, metrics tend to be expensive to produce, often delayed, of poor quality and/or simply absent. An action such as donation of funds to a non-profit organization may rely less on accurate outcome metrics and more on a combination of hope, emotions and even speculation.

The inventions disclosed herein address a variety of novel, non-obvious inventions that improve the accuracy and verifiability of metrics and outcomes.

### SUMMARY OF THE INVENTION

The present disclosure advantageously provides devices, systems, and methods for improving the generation and verifiability of metrics, particularly including outcome metrics. For ease of understanding, we describe the inventions in part using development of metrics to measure the most complex system known: Humans. However, the inventions may be used in other contexts and with regard to other material.

By utilizing cryptographically secure mechanisms, such as those underlying NFTs and cryptocurrency, we teach creating the ability to verify outcomes and purchase outcomes for a variety of purposes including charitable purposes.

### BRIEF DESCRIPTION OF THE DRAWINGS

FIG. 1A is a flow diagram of an existing model of philanthropy.

FIG. 1B is a flow diagram of a model of philanthropy according to an embodiment of the invention.

FIG. 2A is a flow diagram of an existing model of fundraising.

FIG. 2B is a flow diagram of a model of fundraising according to an embodiment of the invention.

FIG. 3A is a flow diagram of an existing model of small donor fundraising.

FIG. 3B is a flow diagram of a model of small donor fundraising according to an embodiment of the invention.

FIG. 4A is a flow diagram of an existing model of policymaking.

FIG. 4B is a flow diagram of a model of policymaking according to an embodiment of the invention.

FIG. 5 is a flow diagram of a DOT model according to an embodiment of the invention.

FIG. 6A is a flow diagram of an existing model of reporting philanthropy metrics.

FIG. 6B is a flow diagram of a model of reporting philanthropy metrics using DOTs and DOT templates according to an embodiment of the invention.

FIG. 7 is a flow diagram of a method for accessing DOT records according to an embodiment of the invention.

FIGS. 8A-8H show code for implementation of embodiments of the invention.

### DETAILED DESCRIPTION OF THE PREFERRED EMBODIMENTS

Reference will now be made in detail to the preferred embodiments of the invention, examples of which are illustrated in the accompanying drawings. While the invention will be described in conjunction with the preferred embodiments, it should be understood that they are not intended to limit the invention to these embodiments. On the contrary, the invention is intended to cover alternatives, modifications, and equivalents that may be included within the spirit and scope of the invention as defined by the appended claims. Furthermore, in the following detailed description of the present invention, numerous specific details are set forth in order to provide a thorough understanding of the present invention. However, it will readily be apparent to one skilled in the art that the present invention may be practiced without these specific details.

### Definitions

DOT: Directed Outcome Token. A unit of social good registered on a blockchain to a user, organization, volunteer, or any combination, usually non-tradable.

DOT template: the definition of the data and procedures required to fulfill and validate a DOT prior to registry on the blockchain.

Small donor: an individual who donates by purchasing DOTs.

Philanthropist: a large donor, foundation or agency who wishes to enable social good at large scale.

Social good: a delivery of service or goods to people in need such the benefit of such delivery can be objectively measured and proven.

Unit of social good: a standardized unit, usually one person, one day receiving a specific benefit at a specific time and place. Examples: a meal, a day of education, needed transportation, a cell phone. Units may be defined as needed but must always include a beneficiary in need.

Social good registry: a blockchain wallet registered to an individual or entity such that the DOTs accumulate over time as donations are made, volunteer hours served, units of social good produced.

Social good entrepreneur (SGE): an individual who fulfills DOT templates and receives donations; or alternatively the founder of a social good organization.

Social good organization (SGO): an organization who fulfills DOT templates and receives funding, usually a not-for-profit.

Social good producer: synonym of social good entrepreneur or social good organization.

Secular tithing: the concept of an individual annual social good budget which is allocated to fund DOTs.

Volunteer DOT: a DOT awarded for volunteering to do unpaid work.

Social good montage: an image or video montage of DOTs.

Social good recipient: the individual, family or community which is the beneficiary of a DOT.

Associated DOTs: DOTs which associate into a larger picture of benefit, such as courses forming a university degree.

DOT validation: the collection of processes and standards which ensure the legitimacy and integrity of DOTs. Examples: digital signatures of DOT producers, audits, spot checks, AI pattern monitoring. Incredible amounts of effort and resources are spent convincing people that taking a certain action will have a certain outcome. In the charitable world, entities like charitynavigator.org go to incredible lengths to measure a variety of things about charities in order to help guide potential donors in making a wise decision. However, while people have needed data about the efficacy of everything from donations to medical procedures for countless years, prior art systems provide no way to accurately and in an auditable manner measure outcome metrics.

Taking a simple example, Jane may provide an average tip of 25% to wait staff at restaurants. However, when Jane goes to a new restaurant, she gets service that reflects a typical tipper, rather than a generous tipper. Similarly, when Jane gets poor service, Jane may wish to provide a smaller tip but cannot do so in an unambiguous manner: Is she simply cheap, or was there a problem with the service? These inventions allow creation and maintenance of records related to Jane that are able to track the outcomes of providing service to her. A record associated with her reservation or otherwise provides access to accurate outcome metrics tied specifically to Jane.

A more complex example is metrics used to pick a charitable organization. The metrics now available are often based on public filings or investigative reporting. For example, https://moneyinc.com/worst-charities-you-shouldnt-be-donating-to/ (retrieved May 17, 2021) warns that Cancer Fund of America gives only 2.5% of its donations to support cancer survivors and research and that the “Committee for Missing Children” only uses 2% of its donations to help children. Even more to the point, however, is that a charity that uses 98% of its money to help those in need, but lacks expertise or efficiency, may provide less help than an experienced charity that uses 60% of its money to help those in need.

The dynamics of a complex system mean that it is possible for a charity to attempt to do good but fail to help anybody. A free medical clinic charity in a very remote and sparsely populated area may spend all of its money providing free medical care but find itself caring only for a few people a week. At the same time, a free medical clinic charity with the same amount of funding in the middle of a big city may spend only 40% of its money providing care to patients but care for hundreds of people in a week. Because prior art systems provide no way for accurately and verifiably tracking actions (such as “did a throat swab” or “took a finger x-ray”), the former charity would score highly on metrics analysis while the latter would score poorly.

### Most Actions are Unseen, Unrecorded, and Unsupported:

It is too common that the records of actions and outcomes are disconnected from reality. According to a 2017 study by HireRight, 85 percent of employers have caught job applicants lying on their resumes. A 2015 study by CreditDonkey found that nearly half of all resumes contain at least one discrepancy between the information provided by the applicant and what the employer finds during a background check. At the same time, it is well known that databases for background checks (and other things) frequently contain inaccuracies. Whether it is putting former U.S. Senator Ted Kennedy on the terrorist “do not fly” list or a credit agency reporting delinquencies incorrectly, the root cause is an inability of the database operator to easily and/or inexpensively and/or rapidly verify data about past actions.

While some people slightly embellish their resumes and others lie about critical elements such as education or expertise, in every case there is the potential for significant harm. In certain jurisdictions, an employee hired based on a fraudulent resume is typically unable to recover compensation for unlawful employment practices (because they could have been fired at any time for lying on their resume). Employers who fail to detect a fraudulent resume may face liability when their new hire commits errors or omissions. Viewed from another perspective, the inability to easily verify resume items can lead to an inability to raise legitimate defenses in a wrongful termination case. Similarly, the value of achievements is significantly increased when it is made more difficult for others to lie about analogous achievements.

While looking at the underlying problem in human event terms is helpful for providing background and context in this teaching document, it is well known that an inability to accurately and, in an auditable manner, verify and certify specific actions and outcomes, is a scourge that interferes with everything from simple database inquiries to aggregation of large data sets for training an artificial intelligence. For example, if a self-driving vehicle is given a speeding ticket, a computing system can easily connect the ticket to the vehicle, enabling the vehicle manufacturer to refine the self-driving system to better avoid the unlawful behavior in the future. However, it is also known that factors such as car color or the ethnicity, race or gender of the person behind the vehicle impacts the likelihood of receiving a speeding ticket, and the contents of that ticket. There is no reason to believe that, compared to driver-driven vehicles, a self-driving vehicle's behavior will not be evaluated by law enforcement with the same risk of bias based on who is sitting in the vehicle. For example, an elderly white female may be driving 50 miles per hour in a 25 miles per hour zone but get a ticket only for exceeding the speed limit by driving 35 miles per hour because the officer feels sympathy for the driver. At the same time, a young, black male driver may be driving 35 miles per hour in a 25 mile per hour zone, but be ticketed by an officer exhibiting bias as if he was driving 50 miles per hour in order to move the offense into the category of reckless driving. This means that adjustments to the software parameters for self-driving vehicles will behave unpredictably because a factor not included in the software—information about the driver's personal characteristics as well as the level of implicit bias present in that ticketing officer's history—is necessary to properly analyze the impacts of software modifications.

The problem exists as well within systems that do not involve humans. For example, an aircraft utilizing lithium-ion battery technology as the primary power source will see variations in battery capacity and performance based on battery temperature. Predictions about the aircraft's range given a battery capacity and charge will inherently be inaccurate because of a lack of verifiable data concerning a variety of environmental conditions impacting the battery. A system that is not cryptographically secure may store historical data about previous battery performance in a variety of conditions, but a lack of security or verifiability means that the database is subject to inaccuracies and manipulation.

Using measurement and recordation of actions that impact social good as an example, people perform actions without creation of any record that can be used to track and analyze efficacy. Some simple examples include:
Giving a friend a ride to the doctor;
Visiting a homebound person;
Volunteering at a community organization;
Helping a child with homework;
Doing a handyman task for a neighbor;
Delivering a meal to an elder;
Helping in a disaster; and
Taking positive environmental actions.

In each case, the actions are valuable datapoints about the person performing the action. For example, somebody who regularly volunteers at a community organization is a far better candidate to put on the organization's Board of Directors than a person who regularly works at that organization in order to fulfil community service requirements issued in conjunction with a criminal conviction. However, privacy laws and the simple lack of a secure and accurate method of sharing such data mean that people who are willing to contribute to communal good are often overlooked when the time comes to find people to help.

We teach, among other things, a cryptographically secure system utilizing a Blockchain to track actions and outcomes. In one aspect, some or all actions and/or outcomes are tokenized into a cryptocurrency. The cryptocurrency can then be traded for actions by third parties. In another aspect, some or all actions and/or outcome may be used to generate a non-fungible token (“NFT”). In yet another aspect, both may be issued for the same and/or different actions as part of the same system. We note that while we reference blockchain, other cryptographically secure and/or auditable mechanisms exist now and may be developed in the future, and this disclosure teaches their use as well. When we reference blockchain herein, unless clearly limited to blockchain, this document is inclusive of other current or future methods that are secure. It is worth noting that future quantum computers may render certain implementations of blockchain insecure, and a quantum-aware blockchain may be implemented.

We further teach a Directed Outcome Token (“DOT”). A DOT is a unit of data reflecting one or both of activities or outcomes, and optionally personally identifying information (such as a name) stored on a Blockchain digital ledger. In one aspect, a DOT may be non-fungible (and may have a data entry on the Blockchain showing as much), such as a record showing that Joe Smith with Social Security Number 123-456-7890 drove an elderly neighbor to the doctor on a specified date. In another aspect, a DOT may be fungible, such as a token reflecting N units of “good deed”, optionally calculated in conjunction with a formula. The system may be implemented for fungible actions only, for non-fungible actions only, or for a combination.

In one aspect, some or all of the DOTs in the system may be cryptographically secured such that they can be decrypted only by a private key associated with a person who earned the token. In this way, private data such as medical records, social security numbers, addresses, etc., may be associated with the record without becoming available to the general public. In one aspect, portions of a single DOT may be so encrypted while other portions may be accessible to the public. In another aspect, a hash or other representation of the underlying data may be utilized.

Expected Outcomes are Merely Predictions of Results, Meaning that they are More Hope Based than Result Based:

Without using DOTs, outcome metrics are expensive to produce, often delayed, and of poor quality. In many cases, outcome metrics are simply absent.

For teaching purposes, we utilize the easily understood example of non-profits to illustrate the problem. Non-profits typically ask for money up front, meaning that donors have to cross their fingers and hope for desired outcomes. Those seeking to maximize the value of their donations are left largely to make speculative donations in a fragmented, emotional and high-overhead system. Indeed, the substantial number of fraudulent fundraises on GOFUNDME illustrate the problem: Anybody can claim to have a problem, need help, or provide help. Without a traceable, secure way to verify it, there is no way to tell the difference between a fundraiser that will help pay living expenses of a homeless veteran and one that will deliver $400,000 to people who created the fundraiser and kept the money themselves (as alleged in https://www.nj.com/news/2018/09/crowdfunding_scams_that_cost_more_than_the_homeles.html). Unfortunately, it takes just a few instances of fraud on donation aggregation sites (such as KICKSTARTER, GOFUNDME, etc.) to sour the public on using such sites, resulting in a fragmented donation landscape where legitimate causes are unable to benefit from the efficiencies of aggregation and non-fragmentation.

Efficiencies in producing socially positive results are nearly impossible to create in an environment where aggregation comes with a material risk of fraud. Similarly, the inability to track the outcomes of a given donation make it difficult or impossible to improve the efficiencies.

In one aspect, a partially encrypted DOT system may be utilized in conjunction with donation or aggregation efforts. For example, each donor may get a DOT indicating publicly how much was donated and to whom, while the remaining data, such as the name of the donor, may be encrypted. In another aspect, the entire dataset may be encrypted and the owner of the DOT (i.e., the donor) able to assert ownership of the claim to the donation by producing the key associated with the DOT.

Each such donor DOT may be associated with one or more recipient DOTs. Taking as an example Abe, a donor, and Betty, a person seeking help for a problem on GOFUNDME, Abe's donation may generate a DOT with records of that donation together with an identifier that indicates where the donation went. That identifier, in one aspect, may include or comprise a key allowing access to outcome data in Betty's DOT or DOTs. If, for example, Betty was seeking money to pay for cancer treatment, her DOT(s) may include the name or names of the providers she got help from and/or an entry made by the provider or providers indicating how much money went to them and what the outcome was. Like the donor data, the recipient data may be anonymized except for those with access to a key.

Additional identifiers may be provided by recipients of help, witnesses, vendors, banks, intermediaries, and others. In addition, jointly entered identifiers may be utilized. For example, a cryptographically secure identifier may be created and jointly signed by a charity, the recipient of the charity's work, and the recipient's priest.

Identifiers for witnesses may be utilized to create additional trust. Indeed, there may be professional (or volunteer) verification actors (such a bankers, judges, priests, rabbis, etc.) who can, in turn, may have identifiers verifying the accuracy of their actions. So Father Abe may be a verification actor, and may have identifiers rating them as trustworthy from Rabbi Bill, Judge Carla, and Ambassador Deena. These identifiers may further reference specific transactions so that somebody looking for further verification of reliability could look to the underlying transactions. Further, Father Abe would have records indicating others who have found him trustworthy, together with the related data. In this way, iterative verification may be made to, in essence, verify the verifiers. While humans are quite good at deception, an interconnected mesh of verifiers make such deception highly unlikely.

It is Common for Actions to Benefit Third Parties, Groups of Third Parties, and/or Society in General, Yet the Benefactor's Donation Goes Unrecorded and/or Unrecognized:

While the inventions are applicable to non-human outcome metrics, for teaching purposes we address them in a human context. We note that mechanical and digital aspects of the inventions exist. For example, if a customer in a high-rise building needs a faster internet connection, the provider may upgrade the system at the expense of, or on behalf of, a single customer. Others in the building, however, would also benefit from the upgraded components. Such an upgrade may be done in an automated way, adjusting router speed caps for example.

There are many things that people do that bring benefits to third parties and/or society generally. Some examples include:
Educational achievements, such as courses, skills and certifications; indeed, most nations have recognized the societal benefits of education and offer free schooling through high school and/or college;
Nutrition improvements, such as gardening fresh food, eating whole foods, avoiding saturated fats and avoiding sugar; indeed, if a single household member adopts such a diet change, the other household members will benefit;
Exercise habits and mental health care benefit the person exercising or obtaining care while reducing health care costs generally, saving the government money (or in the case of the United States, reducing insurance premiums for others);
Structured group participation;
Personal growth programs;
Career and work skills training; and
Social impact entrepreneurship.

In each of these cases (and indeed in most cases where all the benefit of an activity does not inure to the person undertaking the activity), the ability to accurately and/or in an auditable manner record the participation in the activity will improve the likelihood of the activity being undertaken. An auditable record would also permit the societal value of individual activities to be fully or partially made compensable to the person taking the actions.

Sparse and/or Low-Quality Metrics Lead to Poor Outcomes and/or Decision-Making:

As a general rule, metrics are ill-defined within any complex system. As the history of thalidomide shows, within complex biological systems it can take decades to obtain accurate outcome metrics or impact metrics. Indeed, within certain systems it is impossible to even measure outcome metrics within having the act of measurement impact the metrics themselves. This is the case for elements taking place on a quantum level as well as the case for using debugging software in trying to optimize performance when the debugging software is not running.

We find that metrics are often not clearly defined and are often vague. Of course, the more granular and specific the metrics are, the more useful they are in triggering responses. For example, in a facial recognition system, if the metric is “find people who look like me”, the results will include people who meet a threshold level of similarity, but the similarity type will vary from person to person. If the actual goal is “I want to find people with eyes that look like mine”, the similarity type will vary less within the group identified. If the actual goal is further refined as “I want to find people with at least two colors within a single eye” (central heterochromia), the similarity type within a face recognition system would be limited to the exact desired metric.

It is thus desirable to teach a system, method and apparatus for refining the metrics to be used. In one aspect, a frequent proxy for outcome metrics is to measure the inputs. For example, in assessing immunity to the unmutated original strain of Covid-19, the input metric—“did she have two mRNA vaccine shots”—is not the same as directly measuring antibodies to determine whether the body has the threshold level required for immunity. Even such a measurement, which measures an outcome of the vaccine, does not truly measure the outcome sought, which is “is the person immune to Covid-19?” It is thus desirable to use metrics that measure outcomes when possible, and failing that, metrics that are closely associated with outcomes.

Looking at this from a human aspect for teaching purposes, productivity metrics are often measurements of inputs—money spent, hours worked, meetings held. However, simply paying a person a lot of money and having them work a lot of hours and hold a lot of meetings may be only loosely correlated to outcome metrics. The difference may be understood in part by imagining hiring a photographer. The photographer may be able to describe her experience in granular detail, describe the equipment to be used, and describe their methods—none of which means that the photographer has an artistic eye. Similarly, consider hiring a chef. The chef may describe the cost of ingredients and the hours of cooking, but the outcome remains unknown until the food is tasted.

However, a photographer commonly presents potential customers with a portfolio that contains actual outcomes (i.e., photographs taken, edited and displayed), allowing evaluation of the outcome metric. Similarly, a chef can present customer reviews, restaurant ratings, and even samples. Of course, merely providing samples or portfolio access does not guarantee in any way that these samples or portfolio are valid, not computer enhanced, and the actual product of the person.

One way that the inventions are capable of improving the likelihood that such metrics are valid is to incorporate time-based marking. While it would be difficult to prove that a newly added portfolio item is actually new, items can be identified when added to the system. Accordingly, for example, consider four photographs that are part of a photographer's portfolio. The token may encode the upload date for each photograph. If one was uploaded in 2020, another in 2022, another in 2024 and the last in 2026, the system is then capable of analyzing certain differences. Imagine now that the photograph taken in 2020 is flawlessly without motion blur; that in 2022 has slight motion blur, that in 2024 has more motion blur, that in 2026 has significant motion blur. When that photographer uploads a new sample in 2027, it may have no motion blur. The system can identify this as anomalous and flag it as less than fully reliable.

We now consider an analogous analysis of giving. If a user has a record of donating only multiples of 18 (a number with special significance for Jewish donors), a donation of an even $50 would raise red flags as to the veracity of the new donation information. Because past donations have been securely recorded in DOTs, we can verify the amounts of past donations. The user may simply have abandoned the “multiples of 18” approach, and with additional donations the veracity score improves.

With the outcome metric measured, the people involved are able to analyze and answer the questions “did it work”, “what happened”, etc. If a photographer shows a fantastic portfolio of wedding photographs but generates poor outcomes during one wedding, the differences between the weddings, the photographer's mental and physiological status, and equipment can be measured. By contrast, if one measures only the inputs (i.e., photographer's years of experience, the camera used, hours of experience, assistance needed, number of weddings shot, equipment, etc.), trying to figure out why the output did not meet expectations is a nearly impossible task.

Complicating all of this is the disparity in metrics across (and within) organizations. A simple example is tipping at a restaurant. There is no generally accepted metric utilized by substantially all customers. As a result, person who waited tables for decades may be a fantastic tipper and leave a 10% tip in the face of truly terrible service. Another person, one who never waited tables and is financially poorly endowed, may leave a 10% tip in the face of superb service. The pathway from input to outcome is simple: Wait staff provides service; the customer evaluates the service, potentially factoring in things unrelated to service equality, and the customer provides the output—the tip percentage.

A contrasting model would be a tipping system whereby the tip is calculated using a formula that includes time before taking an order, the number of errors, the rapidity with which empty water glasses are filled, etc.

One of the larger problems with unclear metrics subject to no verification or audit is that identical inputs and performance can lead to a wide variation in outcomes. Returning to the wait staff example, it is entirely possible that a customer tells the server that he will tip 50% of the cost of any drinks the server brings for free (i.e., a conspiracy to defraud the restaurant). Even with poor service, the apparent outcome metric is a remarkably high tip percentage.

We teach embedding the metrics used in measuring outputs within the dataset stored in the Blockchain. We also teach embedding actual data, such as video or audio data, within the Blockchain. In one aspect, a checksum may be embedded within the Blockchain, optionally together with a link to the check summed data, so that the metrics can be verified. In one example of why this need is so long felt (yet, until this document, unsolved) is Uber ratings. An Uber driver may provide the same service to 100 riders. 80 of the riders understand the corporate expectation that a 5-star rating must be given, or the driver will suffer with fewer calls and potentially being removed as a driver. If the remaining 20 riders give only 3 stars (assuming, perhaps, that 3 stars means “service provided as expected”)—even in the face of identical driving behavior—the driver would have a score of 4.8 even though there was no substantive difference in service. By encoding video and other metrics of the trip such as speed, internal car temperature, sudden stops or acceleration (or a checksum to data of the trip together with a link), customer facial expressions and/or micro expressions, and customer voice tone, corporate evaluation of driver performance may be freed from the quasi-random differences in rating expectations between customers. In one aspect, it is desirable that the video and rating data be used to train an AI to evaluate driver performance.

### DOT Tokens:

In one aspect, and again using a non-profit for illustrative purposes, one might have DOTs that provide proof of social good (of course, DOTs may also be used for other things, like an auditable method of recording CPU cycles consumed by a program running on a variety of systems). Different types of social good may be standardized as a DOT. For example, there may be a DOT that certifies and records the time, place, people and proof of good done, such as meals delivered, classes taken, support group meetings held, etc.

Within this non-profit example, a DOT would be minted when an instance of the template is proven by a producer. The producer may set an optionally negotiable price for potential donors. Outside of the non-profit example, a DOT may similarly be minted. For example, in measuring the outcomes of crops grown in different regions, a DOT may record the amount of food grown. The DOTs would be recorded in an immutable public ledger.

It should be appreciated that DOTs provide significant levels of proof and may be of use in legal proceedings, proof of tax events, etc.

### DOT Token Donations:

DOT tokens may be associated with a cryptocurrency, but such an association need not be established.

Turning to an example, again within the human context (for greater understanding of the problem and some potential solutions), we imagine a professional (“Jane”), such as an acupuncturist who wishes to help combat veterans. Jane's normal rate is $200/hour, and she must earn $150 per appointment in order to maintain her lifestyle and the viability of her business. Jane would like to dedicate two appointments each week to veterans of limited financial means.

Jane takes on two new veteran clients and uses an “Acupuncture DOT template” (“a-DOT”) (whether on a computer, a portable device or other computing device). For each appointment, she will charge the veteran $25, she will lower her rates by $50, and seek to raise the remaining $125 via the a-DOT. Her hope is that a generous donor or donors will purchase the remaining $125 a-DOT tokens.

A family foundation may then find Jane's a-DOT tokens and decide to donate the money so that she can afford to provide the services to veterans. The a-DOT tokens may be purchased on a one time, weekly, recurring or other basis.

The family foundation is able to prove, using the a-DOT tokens, that they provided a specific amount of help to a veteran (perhaps purely financial, perhaps medical, perhaps job training, etc.). Jane is able to prove that she donated $50 per veteran per week by holding on to $50 of each a-DOT token. All of this is easily auditable and may be used to encourage other donors to donate to Jane's practice and/or to donate to the family foundation so that they can make additional donations.

Looking at another example, unused CPU cycles on computers within a Fortune 50 company may be used for climate prediction in order to better understand climate change, measure greenhouse gas emissions, and/or to better predict weather events. The server sends a portion of the problem to each computer and when the computer returns the data indicating that the portion of the problem has been analyzed, the server assigns a DOT token to the company (which could include a fractional DOT token). The company could then claim, in an auditable manner, to have donated to the effort.

A donor may want to purchase computer time from a cloud computing service such as MICROSOFT's Azure or AMAZON's AWS. The server may respond to each cloud computing data packet received by issuing some or all of a DOT. The donor may then wish to allow others to participate and invites them to purchase the DOT tokens from him, providing him with additional funding to continue to purchase cloud computing time while simultaneously allowing the second donor to purchase an actual verified outcome.

In one aspect, the DOT token (or data within it) may be encrypted in a manner that requires two private keys. The donor and the server issuing the computing problems may both provide their keys upon completion of a task. Once the completion is established, a funding entity (whether an escrow function or otherwise) may then release the second donor's funds.

### Verified Outcomes are a Preferred Way to Transact:

Because the inventions offer the ability to transact with verified outcomes, transactions become more reliable. For example, an auction may be held to sell verified outcomes, such as one hour of Bitcoin mining time on a mining computer with specified GPU capabilities. The mining computer may transfer a DOT (optionally with the results of the hour of mining) verifying that the mining took place. In one aspect, the mining and results may be encrypted so that the results of one hour of mining may be seen immediately after purchase of the associated DOT results in the transmission of a decryption key.

Turning again to the non-profit arena, once outcome metrics become available, competition between entities will focus on outcomes rather than inputs or other factors. Similarly, certain donors may develop a reputation—verified via DOT—for donating in a way that funds preferred outcomes. That donor may make their donation history public (or the DOT may be configured to reveal the donation specifics to the public) in a way that allows others to pattern their donations after the successful donor.

Perhaps more importantly, donations via DOT may be made on a peer-to-peer basis, as discussed above in conjunction with the acupuncturist Jane.

It should be noted that in many cases, the preferred storage modality for a DOT may be to make everything public. However, there are certain cultural traditions—such as the Jewish tradition of Tzedakah—where the anonymity of the donation is considered crucial to the “mitzvah” of donating. In such a case, the donor's identity may be encrypted in a manner that only the donor's private key may decrypt. Decryption may be done for limited purposes, such as taxes or encouraging other donors, without more broadly making the information available.

In one aspect, a unique key may be associated with a specific donor. In this way, a donor's lifetime donations and outcomes may be preserved, creating a digital legacy of philanthropy.

### The Technology Taught Herein Represents Substantial Improvements Over Existing Technology:

The technology taught herein has the benefit of being easily scalable. Blockchain transactions take place countless times every minute, so computing power should not serve as a bottleneck. Similarly, since no human intervention is required to make the system work, humans cannot serve as the bottleneck. Indeed, the calculations required to make the Blockchain function are such that human involvement is not practical or even possible.

Further, by eliminating intermediaries or aggregators, the amount of donated dollars is not reduced by administrative overhead (although donations via intermediaries would still be possible).

One critical element to note is that it is currently not possible for somebody who wants to do good for a living—such as delivering meals to the elderly—to simply sign on in the same way that an Uber driver might. The DOT system makes this possible by allowing the purchase of social good outcomes directly from the person.

In one aspect, a “backdoor” to portions of the transactions that are not otherwise viewable may be provided to the government so that taxes, money laundering laws, and other regulations may be complied with.

### Quality Control:

The Social Metric Token allows inspection and audit of service functions post-delivery. Take, for example, a consultant hired by a company to do culture improvement to make it more friendly to women. The company could implement social metric NFT's validated by women employees and measure and assess the quality and quantity of front-line behaviors, thereby delivering quality control on the management consultant. In one aspect, quality control may be viewed as measuring the units of service delivered. For example, an energy transmission device that receives 100 units of power at the head end and suffers transmission losses of 5 units of power before reaching the recipient end has delivered 95 units of power, representing a unity between quality and delivery metrics. In other cases, such as a device for determining the presence of a stop sign in the context of a self-driving car that is 80% accurate, the goal (safety) is not met and therefore quality control measurement (80%) and efficacy (nearly guaranteed failure over a long enough driving time) are different.

By enabling an auditable and reliable measurement of quality control, services may be measured as having verified track records.

Another benefit of the DOT system is that research and other data may be provided in a verifiable/non-corruptible manner. Taking, for example, phased testing of new drugs, there is a general problem whereby the developers of the drug have a strong incentive to cherry-pick good data while suppressing bad data. By using a Blockchain to record experimental data, whereby the Blockchain contains each data point, it becomes impossible to make bad data simply disappear. This has particular value in times or business areas where facts and verified data are in short supply. In addition, such a system may be utilized for crowd-sourced research, where the data is generated in a distributed way, but collated, formatted and validated by a DOT and/or Social Metric Template NFT.

The Social Credit System in use in China is something unlikely to ever be accepted by major democracies. For example, Americans are unlikely to ever be ok with the government tracking their behavior. However, use of a social good token system allows data to be reliably tracked in a way that can be audited without ever associating the data with identities. This works in a manner analogous to the reason that unlawful transactions are often done with crypto currency: Transactions can be made far more difficult to trace.

It should be understood that in some aspects, DOTs may be modular, and can be nested or daisy chained. For instance, a meal delivered to a homebound senior could comprise an urban delivery DOT as well as an urban garden dot. Similarly, a series or collection of educational DOTs could be bundled to comprise a grade completed, high school graduation, or graduate degree DOT. In one aspect, DOT technology may be utilized to reduce or eliminate resume fraud.

### Extended Discussion of the Drawing Figures

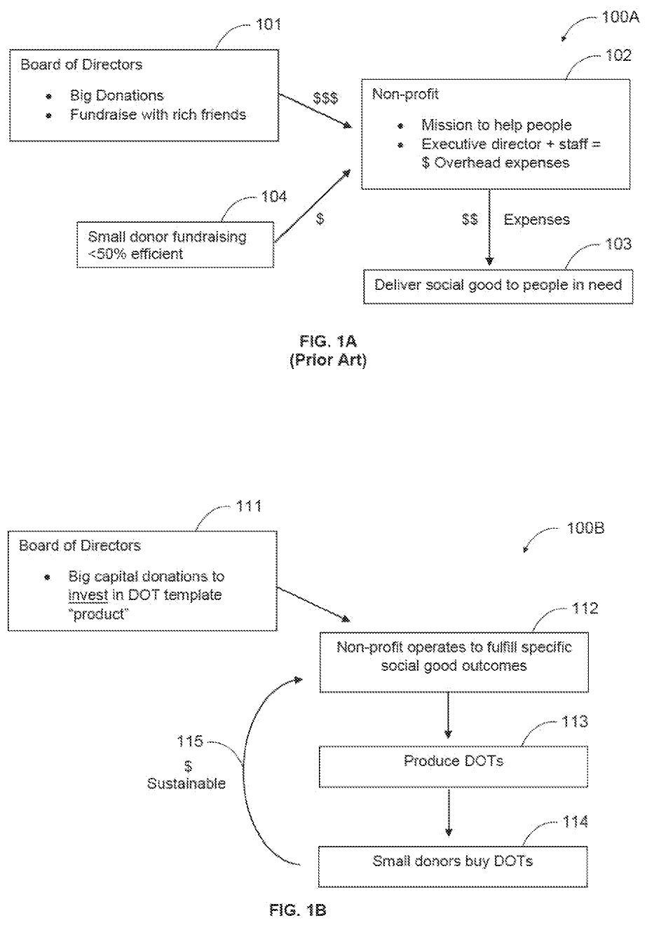

Turning to the drawing figures, we start with FIG. 1A, showing certain prior art systems. A typical organization (in this case we use a charitable organization 100A for illustrative purposes) is run by a Board of Directors 101. The Board of Directors 101 typically raises money through large donors or fundraisers. The Board of Directors 101 typically define the mission of the Non-profit 100A as incurring certain costs in the process of helping people 102. Those investments are typically used to deliver some form of social good to those in need 103. It should be noted that current systems tend to be less efficient when raising funds from small donors 104 for a variety of reasons, including a lack of trust and an inability to verify the efficacy of the charity.

Turning to FIG. 1B, we again use a charitable organization 100B as an illustrative organization. There is a Board of Directors 111 that typically would solicit capital donations to invest in DOT templates, effectively “seeding” the DOT ecosystem. The non-profit then operates in a manner that fulfills specific social good needs 112. The acts that fulfill social good needs are tokenized in the form of DOTs 113. Rather than simply throw money at a non-profit and hope that it goes to something good, a donor can purchase the prior good act as represented by a DOT. In buying the DOT 114, the donor enables the non-profit to reinvest in more social good, creating more DOTs and a sustainable 115 flow of funds and good.

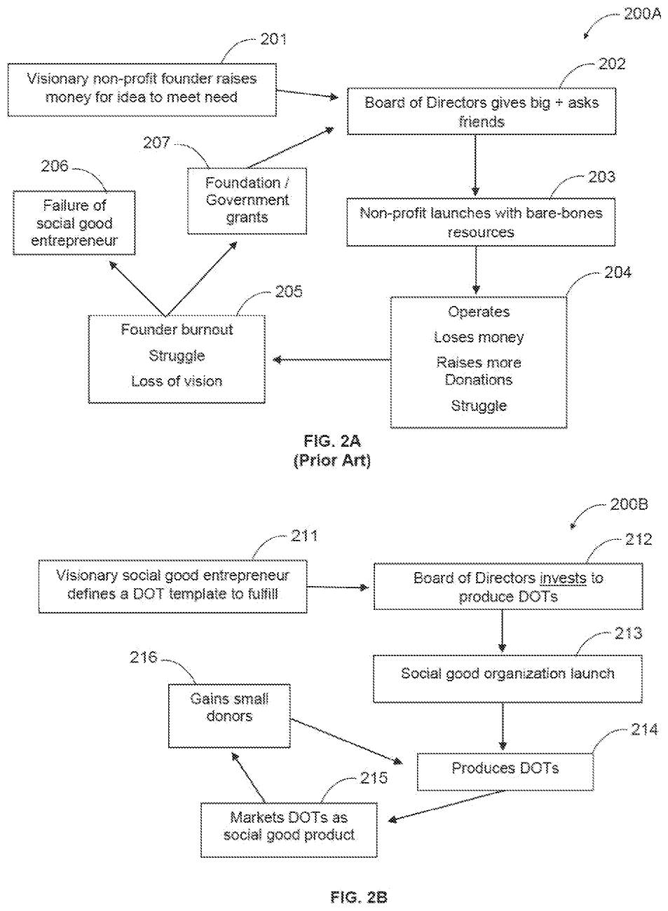

Turning to FIG. 2A, we see a prior art system. We again use a non-profit for illustrative purposes.

A non-profit 200A may be created by a founder who raises money to meet a need 201. As with most entities, a Board of Directors 202 directs the entity and raises funds. The entity (whether non-profit or a startup) typically launches at the point when they have obtained sufficient resources to begin operations, even if it falls short of the preferred resource level 203.

For the majority of non-profits (and many startups), the entity struggles to meet operational needs, attempting to direct its resources to its mission only to find it is short of resources 204. Not atypically, the founder experiences burnout; the entity struggles; and the entity may suffer from a forced abandonment of the fully dimensionalized original mission due to resource constraints 205. The social good entrepreneur may simply fail and give up 206 or may have to turn to other funding sources 207 in hopes of keeping the non-profit limping along.

Turning to FIG. 2B, we see how aspects of the inventions may be used to prevent the entity from financially circling the drain. As in prior systems, a new entity 200B typically begins with a visionary 211. We use a non-profit as an exemplary system again. In this case, the visionary social good entrepreneur defines a DOT template to fulfill 211. The DOT template sets out the acts of social good that are desired. Thus, for example, if the social good is providing meals to the elderly, the DOT template may effectively serve as an order for a meal (or meals). A number of DOTs are then generated from the template based on investments as directed by the Board of Directors 212. The organization can then do a formal launch 213 and produce DOTs 214 as it does social good. Because each DOT represents at least an act of social good, those may be marketed 215 and the proceeds 216 reinvested in the provision of additional acts of social good, which in turn produce more DOTs 214 that may be marketed 215.

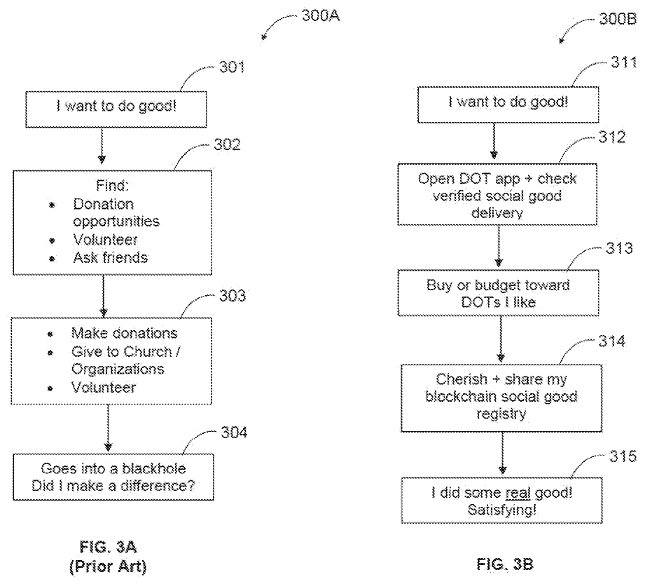

Turning to FIG. 3A, we see another illustration of the problem 300A. We again use a non-profit as an exemplary entity. In this case, an individual may decide they want to do something good 301. They then look for opportunities 302 and in turn make donations, provide gifts, or volunteer 303. Apart from a potentially unreliable “thank you”, it is nearly impossible to determine if they actually achieved their goal 304. Perhaps more to the point, they have no way to determine if the charitable path they walked provided the highest and best use of their resources.

Turning to FIG. 3B, we have an illustration of a solution to the problem 300B. An individual who decides to do something good 311. Rather than guess or flounder about for a cause, they are able to access catalogues of DOTs to find actions they want to sponsor 312. They can buy or budget toward paying for such acts 313. They are then possessed of a cryptographically secure and public way to measure their social good 314, 315.

It is worth comparing charitable giving and the function of paper currency in the context of social good. Paper currency, in its simple form, is a way to store the value of work performed or goods sold. Alice may work for ten hours at thirty dollars per hour after tax. She is then given three hundred dollars, which represent the value (or some of the value) of her work. She can then wait anywhere between minutes and decades to convert her work from its storage medium (paper money) to goods or services. Put another way, money is typically paid in consideration of work already done or goods already provided. This sequencing allows people to evaluate work performed or goods provided prior to paying for them.

By contrast, charitable giving is nearly always done in the opposite sequence. A charity says it will do good deed in the future in exchange for cash now. It is unclear how much value the good deed will hold to the recipient, and it is unclear whether the good deed is cost effective or worth what it costs. Indeed, it is possible that the charity changes directions and takes the money and then fails to perform the good deed.

The instant inventions flip the script, allowing charitable giving to be done in a manner analogous to the kinds of transactions familiar to people. That is, they can look through a list of deeds that have been performed and choose to purchase one. They know in advance what they are paying, what the deed was, and that it was in fact performed. Prior art systems are simply incapable of performing this switch.

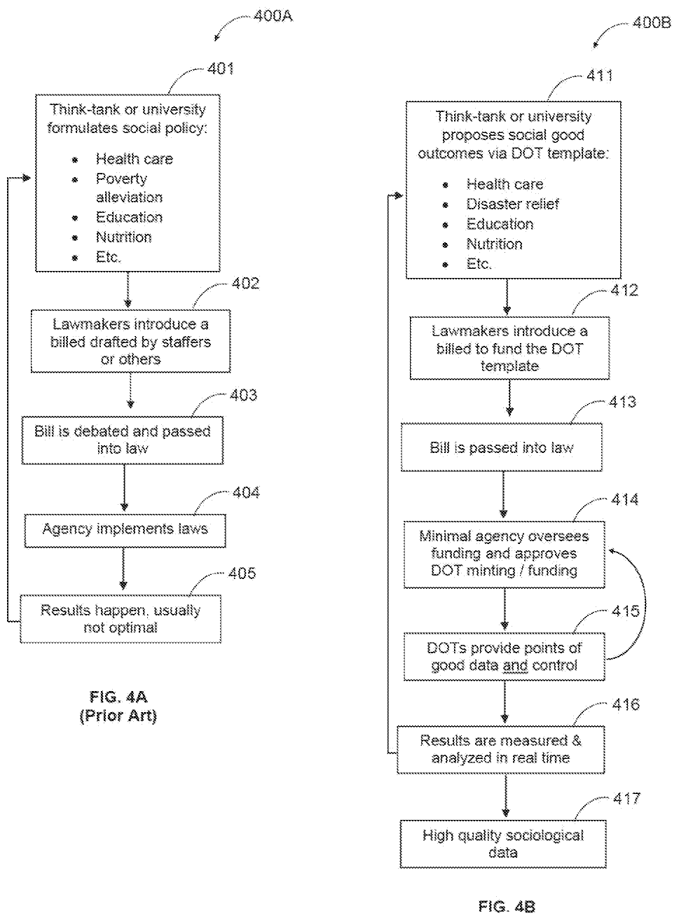

Turning to FIG. 4A, there is shown a conventional method of policymaking 400A. We look at an entity such as a think-tank or a university that may formulate social policy in a variety of areas 401. That policy is then suggested to lawmakers, who introduce and pass a bill 402, 403. The policy is then implemented by an agency 404, with unpredictable results 405.

By contrast, the policymaking 400B as shown in FIG. 4B in the context of DOTs is quite different. We again look at an entity such as a think-tank or a university that may formulate social policy in a variety of areas 411. Legislators may then fund a DOT template 412, 413. Governmental oversight may be utilized over DOTs 414, but governmental involvement is less critical and extensive as it is without DOTs. DOTs may be used to validate data and provide a level of control 415, allowing real time analysis 416 and generation of high-quality data 417.

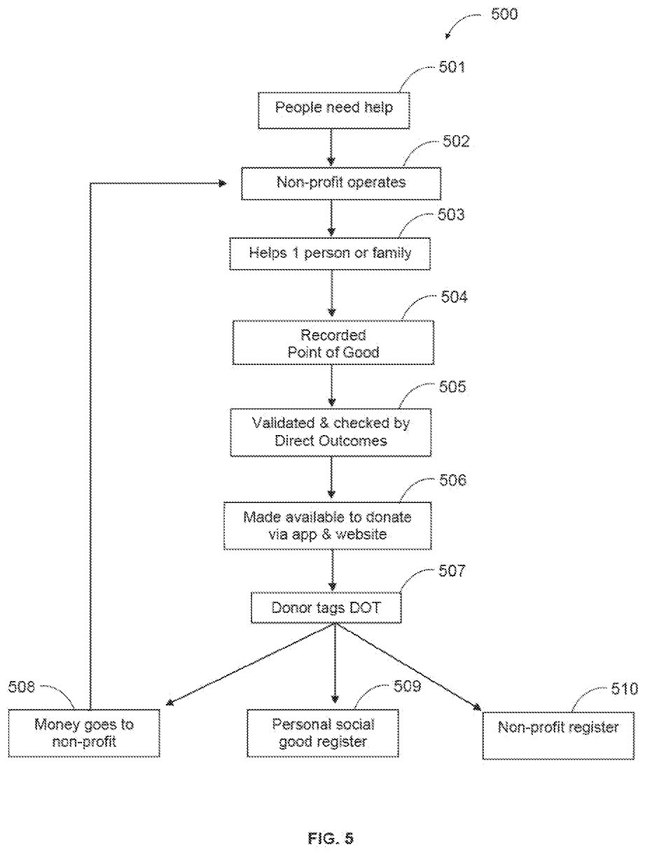

Turning to FIG. 5, we see the flow of an implementation of one aspect of the inventions 500. We begin with people who need assistance 501. They connect with a non-profit 502. The non-profit provides help for a person or family 503. The assistance is recorded, validated and checked at a DOT 504, 505. The DOT is then offered for sale 506 and purchased by a donor 507. The donor then tags and/or owns the DOT. The purchase funds (or a portion thereof) may be returned to the non-profit 508. It may also be associated with the donor's social good register 509 or a non-profit register 510, or both.

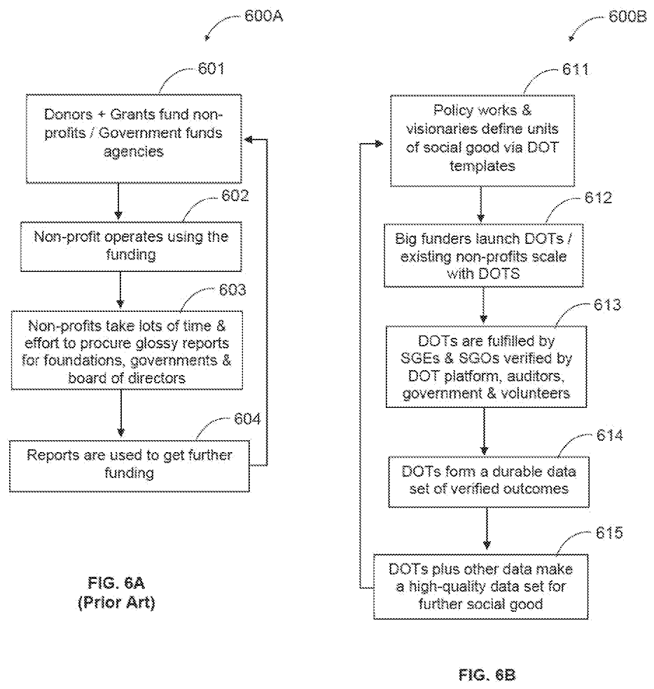

Turning now to FIG. 6A, we see a conventional method 600A for funding and operating a non-profit. The non-profit may receive funds from donors and, possibly, from government grants awarded by government agencies 601 with a similar goal or mission to the non-profit. The non-profit then operates using the funding 602. At least some of the funding of the non-profit is used to produce reports for the donors, government agencies providing the grants and the non-profit's board of directors 603. At 604 the reports are used to attract further funding from donors and government agencies providing grants.

FIG. 6B shows an exemplary method 600B for using DOTs for funding and operating a non-profit, according to an embodiment of the invention. At 611 visionaries use DOT templates to define units of social good. Then, large donors launch non-profits using DOT templates and/or existing non-profit organizations scale up using DOT templates 612. At 613 DOTs are fulfilled by social good entrepreneurs and/or for social good organizations and are verified by DOT platforms, auditors, the government and/or volunteers. The verified DOT outcomes are then stored 614 (typically on a blockchain or other permanent storage media) and form (with other data) a high-quality data set for further social good 615. The process then repeats 611 as non-profits continue social good policies and/or define additional DFOT templates to promote social good.

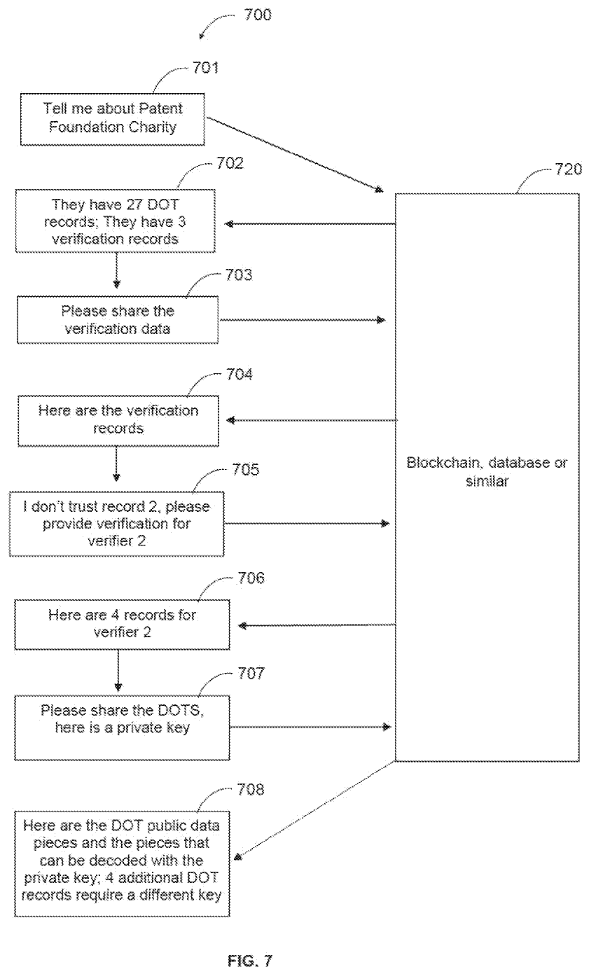

FIG. 7 shows an exemplary method 700 by which potential donors can obtain verified records about a particular charity using DOTs. At 701 a potential donor makes an inquiry to a database, blockchain or other information storage medium 720 regarding a particular charity (e.g., the “Patent Foundation Charity”). At 702 information is returned to the user about the charity. In the example here, the information is that the Patent Foundation Charity has 27 DOT records, and three verification records. At 703 the potential donor requests that the database, blockchain or other storage medium 720 share the verification records of the charity, and at 704 the verification records are provided to the potential donor. In the exemplary method of FIG. 7, the potential donor questions the veracity of one of the verification records (e.g., record 2) and requests from the blockchain, database or other storage medium 720 verification for verification record 2 705. At 706 records are returned (e.g., four records for verification record 2) to the potential donor. After reviewing the verification data, the potential donor may then trust that the charity does verifiable social good, and at 707 request that the charity's DOTs be shared, while providing to the blockchain, database, or other storage medium 720 a private key to unlock such information. At 708 the DOT public data and the DOT pieces that can be decoded with the potential donor's private key are provided to the potential donor. In some aspects, the blockchain, database, or other storage medium may also indicate that additional DOT records are available, but require a different key to unlock such records.

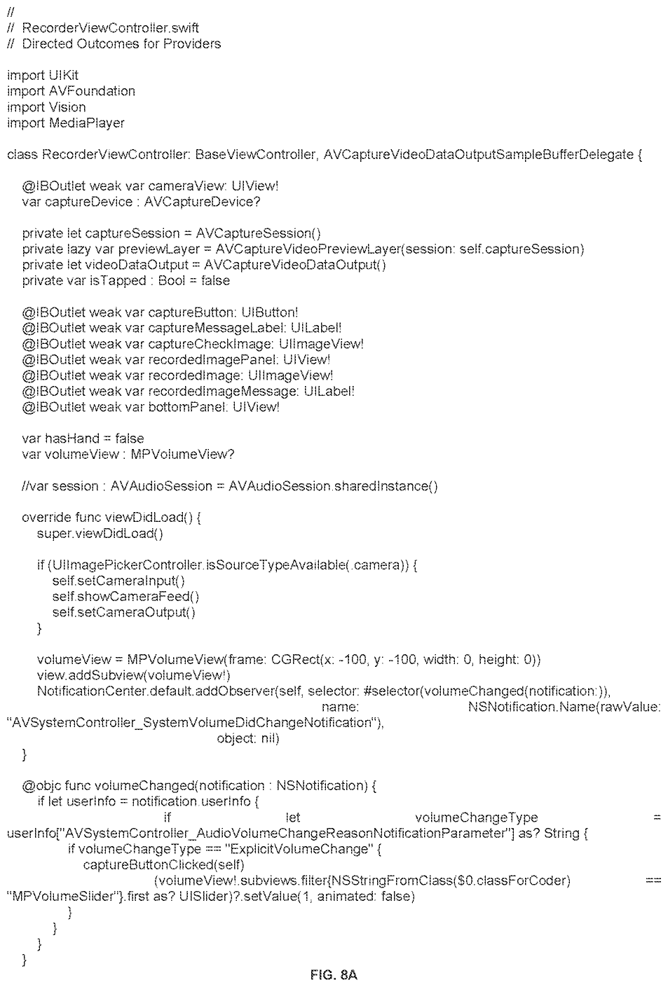

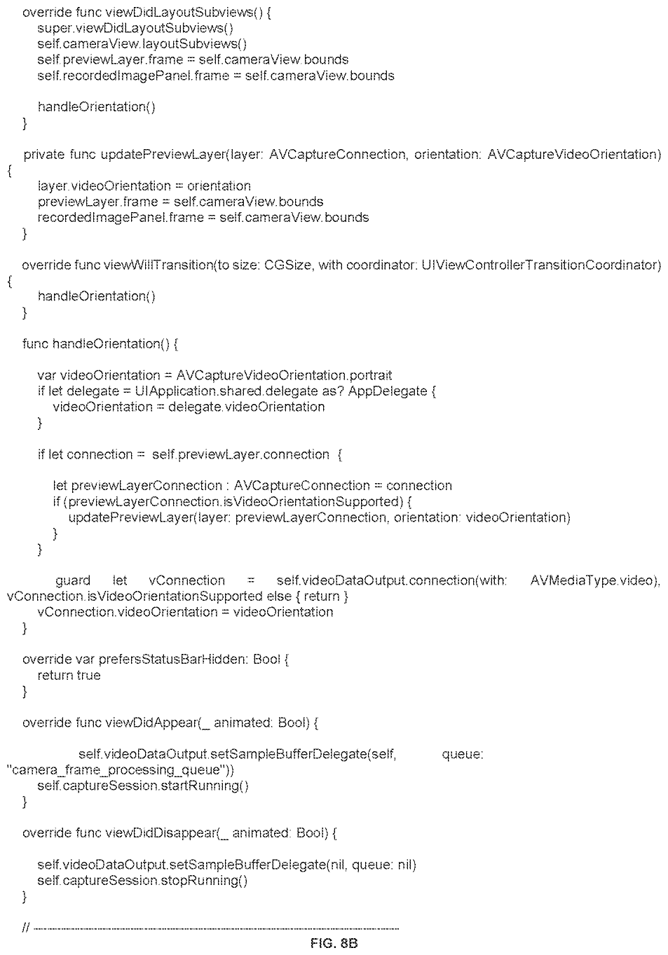

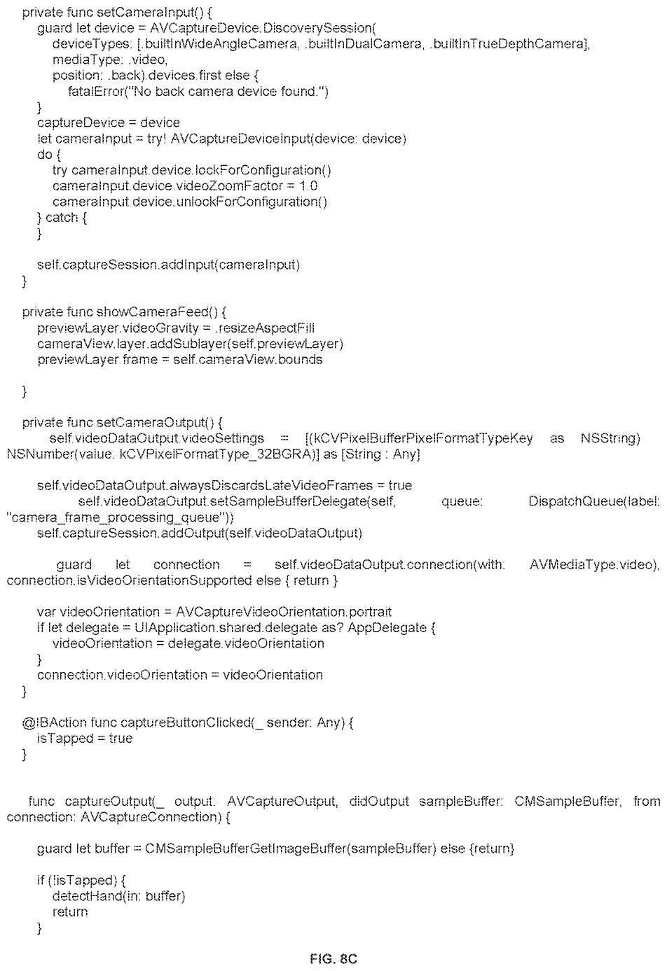

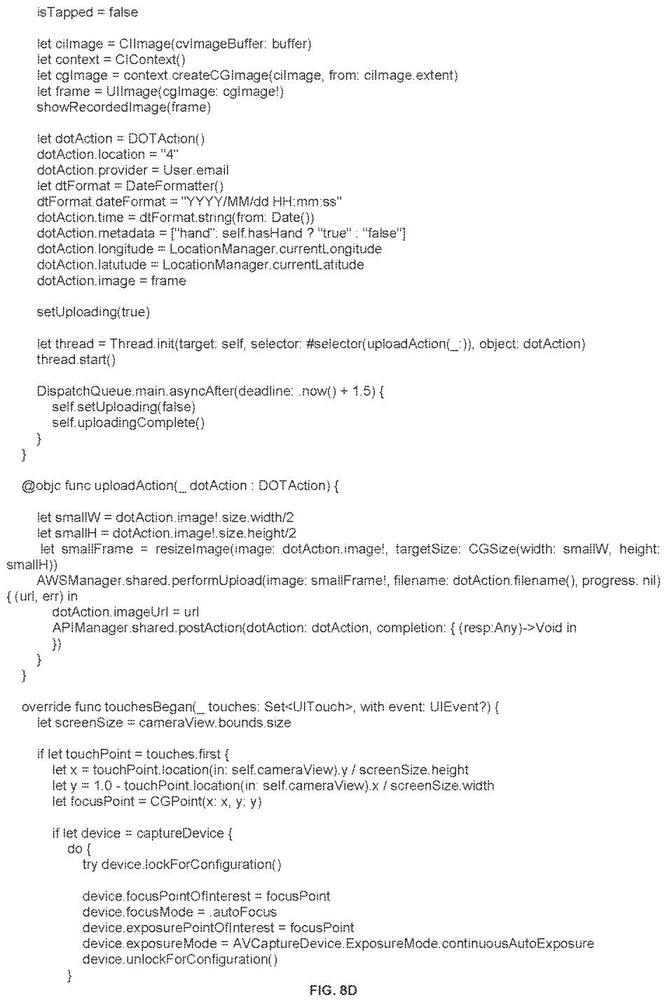

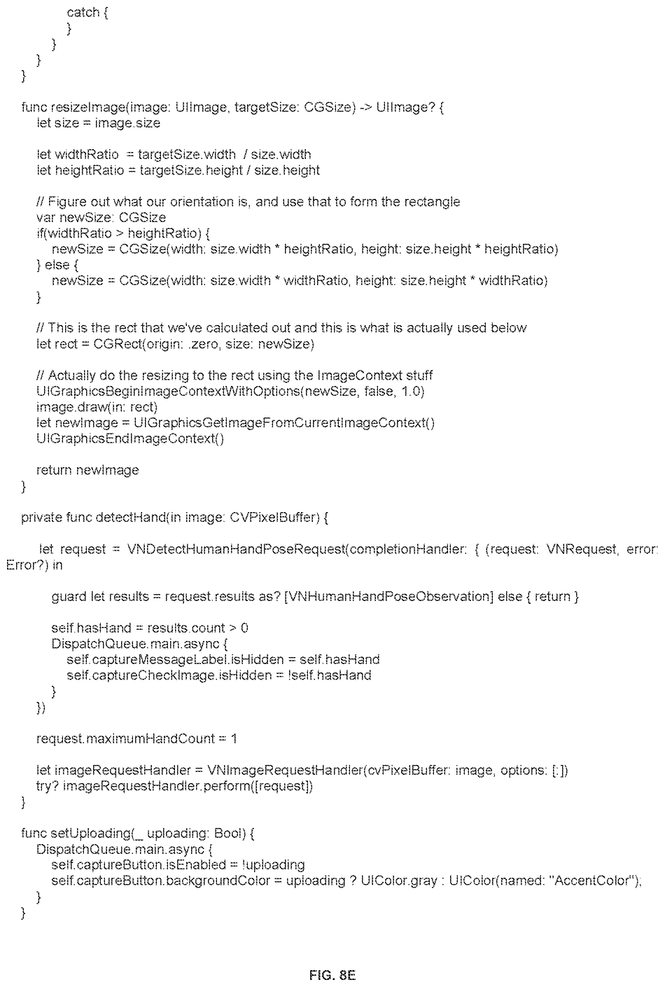

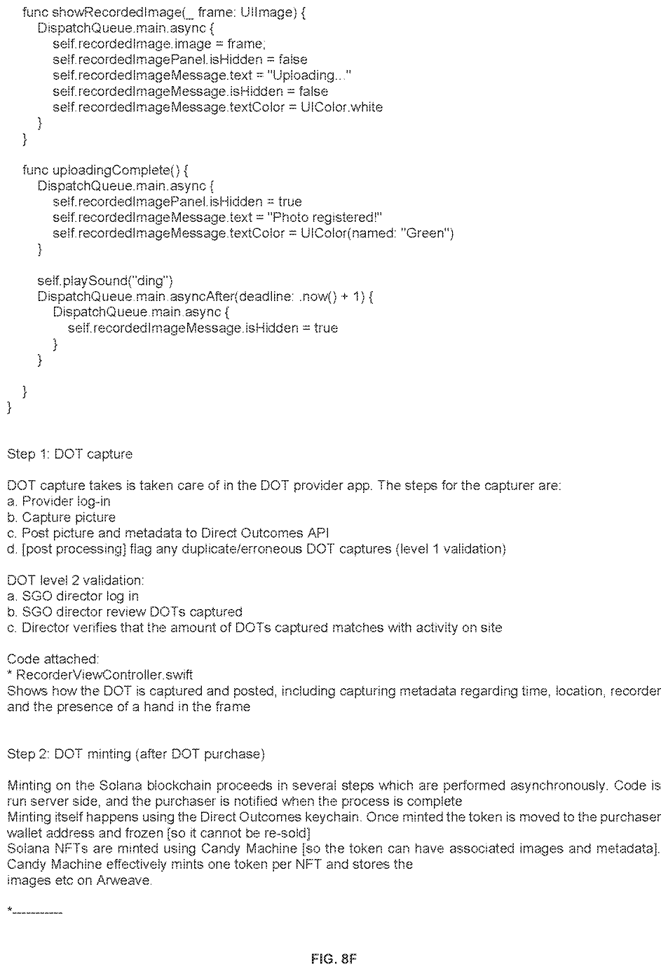

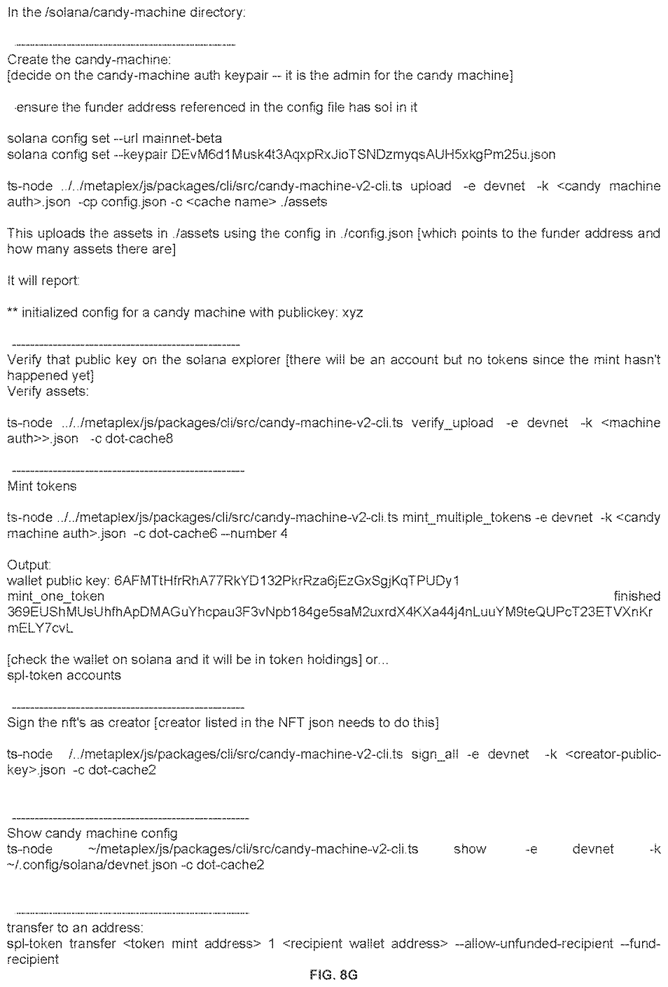

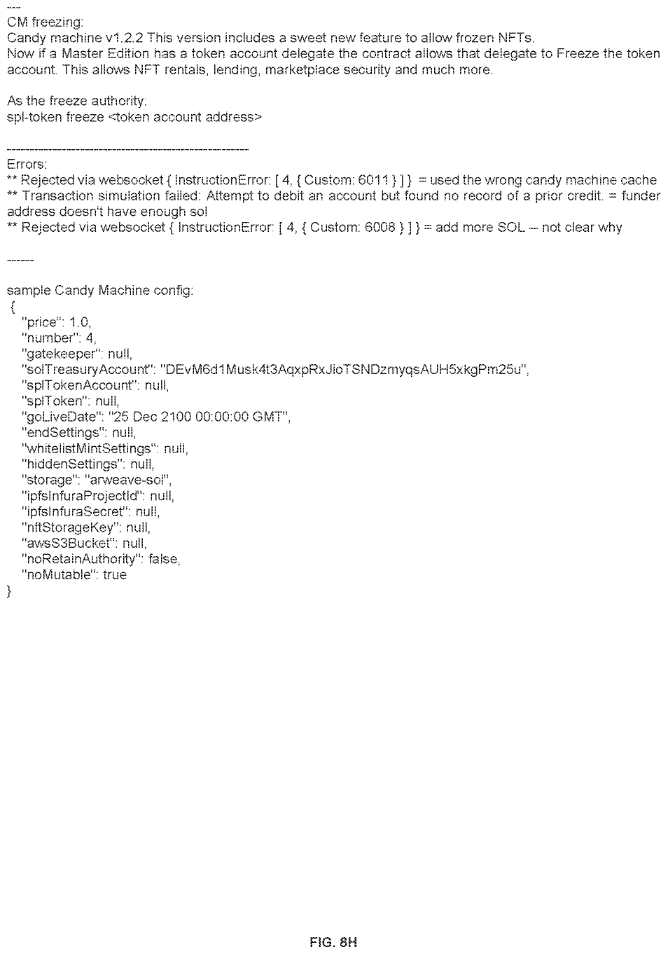

FIGS. 8A-8H contain software code for implementation of one or more of the methods described above.

Turning now to additional examples and implementation issues, we note that a gatherer may be utilized. They would be at the point of service delivery and verify that photographic evidence is accurately and uniquely captured. This may be implemented using AI, computers, people, or a combination thereof. Similarly, a Director may be utilized to ensure that the claimed in the DOT match what actually happened. In one aspect, verification could be an email, an app entry, the foregoing accompanied by biometric data, or otherwise. The system may also implement quality control to ensure that all mandated steps in the DOT template are met.

One example may be drawn from food distribution. Consider a significant shortage of, or disruption to, grain supply. Such a shortage threatens famine in less affluent nations. We note also that livestock and biofuel uses in wealthier nations could be repurposed to feed humans. Less than half of global grain supplies are used to feed humans, while one third of global grain supply is used as animal feed and the remainder used for other purposes, such as biofuel and seed stocks.

A common response to a child's decision not to eat their food is that “people are starving in poor countries, don't waste”. Leaving aside the health concerns that forced consumption brings, the most common retort—from a child—is that there is no way to get their leftovers to those countries. Stepping back, we see the same problem identified by children undergirds much of global hunger. There is no easy way for individuals to feed starving people thousands of miles away.

We teach using DOTs to fund grain purchases for poor countries. It is a mechanism by which human food needs may be prioritized over other uses of grains. In terms of minting new DOTs, they may contain information comprising some or all of: (1) Recipient information; (2) GPS information; (3) Level of need in that geographic region; (4) point of help record; (5) verification/units of help defined; (6) supply chain or other interim costs, such as trade finance and working capital; (7) organizations involved; (8) governments involved; (9) tax receipt or other tax information; and (10) charity information. The DOTs may be pre-funded by individuals, charities, governments, others, or a combination thereof.

In one aspect, efficacy of distribution may be recorded in the DOTs. In this way, DOTs associated with dangerous or poor distribution practices will be less likely to be acquired by donors, creating an incentive to improve distribution mechanisms/practices.

It should be understood that DOTs may be considered critical infrastructure if incorporated into global food sufficiency efforts. Indeed, by using cryptographically secure means to prove distribution efficacy, governmental or organizational corruption is alleviated as a barrier to food security work.

DOTs may be considered to be in various states and may be categorized in some implementations by state. For example, a DOT that has been created and verified as truly reflecting actions may be considered as a “validated DOT”. A DOT being offered for purchase may be a “marketed DOT”. A DOT that has been transferred away from the entity that generated it may be considered a “sold DOT”.

In this disclosure, we teach creation of a digital record of acts. In one aspect, a durable digital legacy or social good registry (or similar) may be created for individual donors; organizations; volunteers; families; corporations; foundations; schools; and others.

It should be noted that DOTs may be associated with acts of good or charity; acts taken by or in association with a business; any act for which a secure record is desirable; or bad acts. In one aspect, the bad act token may be held and viewable to the public unless purchased (presumably by the bad actor) for an amount that is acceptable to mitigate the damage the bad act caused.

In one aspect, DOTs may be subject only to a single sale. In many cases, it is desirable to prevent DOTs from becoming transferrable. For example, in the context of a charity, if homebound Alice is provided a meal by the charity and Ben purchases the DOT associated with that meal, Ben's purchase is used to fund additional good acts. However (and particularly where a system for aggregating or otherwise displaying information from multiple DOTs allows for a reputation to be established), if Ben were to resell that DOT to Carrie, none of the proceeds would be given directly to the charity. Indeed, because Carrie attaches a secondary value to DOTs, in this case creating the impression that she is very philanthropic, she would see value in a DOT that Ben, who does not need peer affirmation to know he is good, does not. Ben may therefore be willing to resell the DOT for pennies on the dollar to Carrie. Such a secondary market in DOTs poses a threat to functioning of certain kinds of DOTs, such as charitable ones.

In one aspect, DOTs may be utilized to create a feeling of connectivity to an act, such as by including a photograph of the person being helped. In another aspect, the DOTs may contain information about whether the recipient consents to sharing their information, and if they do, may make available to a DOT purchaser social media information or other information.

In thinking about DOTs, practitioners of the art should be aware that current charitable giving is done in one of two manners: synchronous (such as a homeless person asking for food and the donor giving them a bag of leftovers they are carrying) and asynchronous (such as a homeless shelter asking for money to buy food, receiving the donation, and later providing a meal for a homeless person). However, when charities are concerned, the only asynchronous donations that are possible under prior art systems follow a specific order: Donation first, then social good. DOTs allow asynchronous transactions in the reverse order: A verifiable act of good takes place first, then the DOT is transferred in exchange for a donation that covers some or all of the act of good.

In the context of charity, DOTs may be offered in exchange for covering operational expenses of an entity. In so doing, a downward pressure may be created on overhead costs for the charity as it may be difficult to find donors willing to purchase large numbers of administrative overhead DOTs. In another aspect, some or all of the overhead costs may be incorporated into the DOT. In such a case, particularly where the DOT record breaks down cost sources (for example, “meal for Florence, food costs $3.39; fuel and transport: $2.15; administrative overhead: $1.11; total $6.65”), a donor is capable of determining which DOTs that have been more efficiently created and maximize their own social good by selecting DOTs where the benefits to the beneficiary are high compared to the overhead.

In one aspect, near field computing (such as Bluetooth) or mid field computing (such as Wi-Fi), location information, or other data may be utilized to generate, in full or in part, the DOT. For example, Anne's Soup Kitchen may be a non-profit dedicated to feeding the poor. Barny picks up a package of five meals and delivers them to Cherri's family. When Barny delivers the package, his phone may detect or communicate with Cherri's phone, may utilize GPS, triangulation of signal, and/or may detect the Wi-Fi system at Cherri's house to determine that Barny's phone was at or near Cherri's house. In another implementation, an RFID tag may be placed on the food. Barney's phone reads the tag when he picks it up. Cherri's phone reads the tag when he delivers it. One or both devices may provide data to be incorporated into the DOT, substantially reducing the risk of diversion of resources or fraud or other forms.

In a preferred implementation, the DOT would contain evidence or proof that the conditions of the DOT have been met. For example, a template may be “one basket of free groceries distributed to a person in need”. The DOT may contain a photograph of the basket of groceries including the hands of the recipient. In one aspect, AI, checksums, vector graphic analysis, fingerprinting, or other means may be utilized to ensure that the photograph is unique. Metadata may be analyzed to verify the photograph was not taken at a time or place inconsistent with delivery or that it contains data indicating that the time and/or place of delivery matches that which is expected.

It should be understood that any examples given are not intended to limit the invention to these embodiments. On the contrary, the inventions are intended to cover alternatives, modifications, and equivalents that may be included within the spirit and scope of the invention. In other instances, well-known methods, procedures and components have not been described in detail so as not to unnecessarily obscure aspects of the present invention. These conventions are intended to make this document more easily understood by those learning, practicing or improving on the inventions, and it should be appreciated that the level of detail provided should not be interpreted as an indication as to whether such instances, methods, procedures or components are known in the art, novel, or obvious.

1. An apparatus for providing verifiable outcome metrics, comprising:
a computing device comprising;
a memory, a processor, and a storage medium containing instructions, the instructions causing the computing device to:
receive data comprising an actor, an action, and an outcome comprising a measurement of an effect of the action;
encode the data; and
record the data on a blockchain.

2. The apparatus of claim 1, wherein the encoding comprises encryption with a private key.

3. The apparatus of claim 1, wherein the data further comprises image data showing some or all of the outcome.

4. The apparatus of claim 1, wherein the data further comprises a verification from a first third party verifier.

5. The apparatus of claim 4, where the data associated with the first third party verifier is, itself, verified by a second third party verifier.

6. The apparatus of claim 1, wherein the data further comprises links or references to additional similar actions.

7. The apparatus of claim 6, wherein the data further comprises links or references to additional outcomes of the additional similar actions.

8. The apparatus of claim 7, wherein the data further comprises links or references to the additional similar actions by the actor.

9. The apparatus of claim 1, wherein the instructions further cause the computing device to create a DOT based on the data.

10. An apparatus for providing transferable outcome metrics, comprising:
a computing device comprising a memory, a processor, and a storage medium containing instructions, the instructions causing the computing device to:
receive data comprising an outcome;
encode the data; and
record the data as a DOT on a blockchain;
where the computing device further receives instructions to cause transfer of the DOT to an actor in response to the second actor taking an action.

11. The apparatus of claim 10, wherein the action comprises provision of something of value.

12. The apparatus of claim 11, wherein the computing device transfers some or all of the something of value to the actor.

13. The apparatus of claim 10, wherein the DOT is stored as a non-fungible token.

14. The apparatus of claim 11, wherein the something of value is tokenized as a DOT or a non-fungible token.

15. An apparatus for creating a record for an actor, comprising:
a computing device comprising a memory, a processor, and a storage medium containing instructions, the instructions causing the device to:
receive data comprising an actor, an action, and an outcome;
receive, retrieve or create a unique identifier associated with the actor;
create a DOT based on the data; and
associate the unique identifier with the DOT.

16. The apparatus of claim 15, wherein a score is generated based on a plurality of outcomes associated with the unique identifier.

17. The apparatus of claim 15, wherein an aggregation of a plurality of outcomes associated with the unique identifier and a category of action is used to create a score.

18. The apparatus of claim 15, wherein an approximate transaction time is a portion of the data.

19. The apparatus of claim 15, wherein the actor's charitable history over a period of time is used to generate a charitable activity score.

20. The apparatus of claim 15, wherein the unique identifier is not publicly associated with the actor.
